(19) United States
(12) Patent Application Publication
(10) Pub. No.: US 2026/0121386 A1
(43) Pub. Date: Apr. 30, 2026

(54) STACKABLE POWER DISTRIBUTION SYSTEM INCLUDING MULTIPLE POWER DISTRIBUTION UNITS IN ELECTRIC VEHICLES

(71) Applicant: International Truck Intellectual Property Company, LLC, Lisle, IL (US)

(72) Inventors: Bruce Turner, Plymouth, MI (US); Irving Hernandez, Oxford, MI (US)

(73) Assignee: International Truck Intellectual Property Company, LLC, Lisle, IL (US)

(21) Appl. No.: 18/925,149

(22) Filed: Oct. 24, 2024

(51) Int. Cl. H02B 1/46; B60L 1/00; H02B 1/20

(52) U.S. Cl. CPC H02B 1/46; B60L 1/00; H02B 1/20

(57) ABSTRACT

A power distribution system is provided that includes a first Power Distribution Unit (PDU) and a second PDU. The first PDU and the second PDU each include a plurality of first PDU power outputs and open tops and bottoms that expose busbars located in the PDUs. The second PDU is placed atop the first PDU and forms a seal between the two PDUs. Electrical connection fasteners are used to electrically and mechanically connect the busbars in the first PDU to the busbars in the second PDU. The bottom opening of the first PDU is hermetically sealed with a bottom lid, and the top opening of the second PDU is hermetically sealed with a top lid.

### FIELD OF THE INVENTION

The present disclosure relates to power distribution units (PDUs), and more particularly to a stackable power distribution system including multiple PDUs for use in an electric vehicle.

### BACKGROUND

Electric vehicles (EVs) are becoming more and more common. Different EV types have different needs to power auxiliary devices. Auxiliary devices are commonly powered with High Voltage (HV) power. Because of their size and large passenger cabin, buses typically require a higher count of heaters and compressors used to maintain the desired temperature of the passenger cabin.

In order to power all of the auxiliary devices, the HV Power Distribution Unit (PDU) needs to account for the correct number of power outputs. Since the PDU volume is limited to the available space in the vehicle layout, the PDU is designed to have the smallest possible footprint. Although this small footprint helps in fitting the PDU into the EV, this small size limits the number of power outputs that can be included in the PDU.

The PDU typically includes a fixed number of outputs. If a PDU has more inputs than are needed, the PDU is underutilized and thus the design is excessively expensive and overly large. Conversely, if the PDU has too few outputs then a second PDU would be required, which may not always be feasible, depending on the packaging limitations in the vehicle layout.

A need therefore exists for a power distribution system that does not have too large of a footprint while still providing a sufficient number of power outputs for the auxiliary devices used in an EV.

### SUMMARY OF THE INVENTION

An exemplary embodiment of the present disclosure provides a power distribution system for use in an electric vehicle. The power distribution system includes at least two PDUs that are preferably stacked to provide for increased power outputs without increasing the footprint of the power distribution system. The PDUs each include a plurality of power outputs and at least two busbars. Each of the PDUs has an open top and bottom, although the bottom PDU can have a preformed bottom. The open tops and bottoms expose the busbars that function as the main electrical conductors inside of the PDUs. The open tops and bottoms allow PDUs to be stacked, thereby decreasing the required footprint for the power distribution system.

The PDUs each include busbars, which provide electrical power to the PDU for distribution to various systems within the EV. An exemplary embodiment of the present disclosure provides at least two electrical connection fasteners that electrically connect the busbars in adjacent PDUs. This alleviates the need to bring multiple power lines into multiple PDUs. The electrical connection fasteners also preferably provide mechanical connection between the PDUs.

The lowest PDU in the power distribution system is preferably fitted with a lid to seal the electrically conductive internal parts from external agents, while the top PDU is preferably fitted with an upper lid.

By enabling the PDUs to stack on top of each other, the number of outputs can be increased on a need basis while minimizing the footprint required to make the connection for a second PDU. It should be understood that additional PDUs can be stacked and utilize the same configuration as discussed above.

### BRIEF DESCRIPTION OF DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 depicts an exploded perspective view of a stackable power distribution system that includes multiple power distribution units in accordance with an exemplary embodiment of the present disclosure.

FIG. 2 depicts a top plan view of a power distribution unit in accordance with an exemplary embodiment of the present disclosure.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

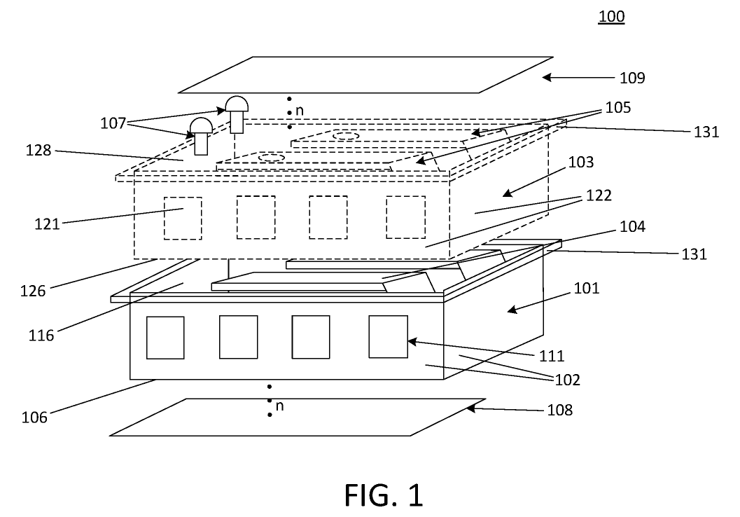

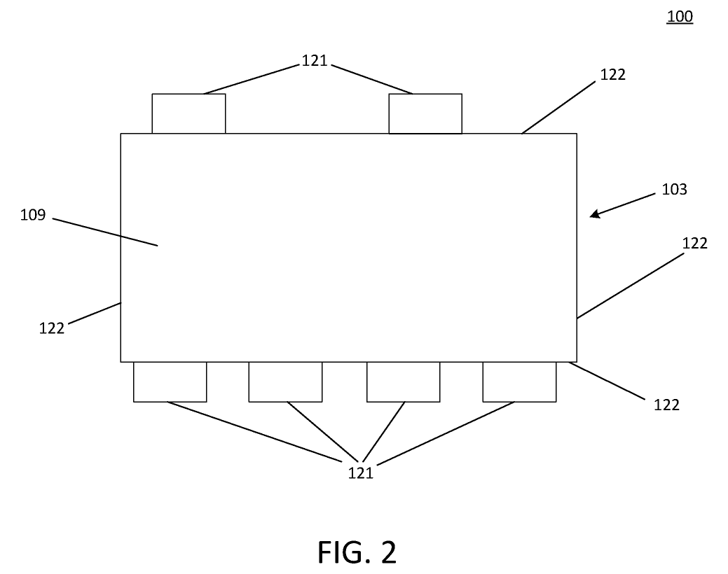

The following detailed embodiments presented herein are for illustrative purposes. That is, these detailed embodiments are intended to be exemplary of the present disclosure for the purposes of providing and aiding a person skilled in the pertinent art to readily understand how to make and use the present disclosure. While certain shapes and materials are used in some embodiments, they are by no means an intention of restriction. The present disclosure can be better understood with reference to FIGS. 1 and 2.

FIG. 1 depicts an exploded perspective view of a stackable power distribution system 100 that includes multiple power distribution units in accordance with an exemplary embodiment of the present disclosure. FIG. 2 depicts a top plan view of stackable power distribution unit 100 in accordance with an exemplary embodiment of the present disclosure.

Stackable power distribution system 100 preferably includes a first Power Distribution Unit (PDU) 101, a second PDU 103, at least two electrical connection fasteners 107, a lower lid 18, and an upper lid 109. PDUs can also be referred to as electric vehicle high voltage power distribution boxes or electric vehicle power units. First PDU 101 and second PDU 103 are devices fitted with a plurality of power interfaces 111 and 121. The plurality of power interfaces 111 and 121 include power outputs designed to distribute electric power within an EV. In some embodiments, the plurality of power interfaces 111 and 121 may further include one or more power inputs designed to receive power from a power source in order to redistribute the electric power to the EV.

PDUs 101 and 103 in EVs are preferably high-voltage units that deliver power to all critical loads within the EV. PDUs 101 and 103 also protect electrical and electronic components and vehicle occupants with reliable circuit protection. PDUs 101 and 103 can power, for example but without limitation, the battery, a charger, air conditioning system, heating and defroster systems, various pumps, auxiliary loads, steering, brakes, and traction control systems.

First PDU 101 preferably includes busbars 104, a plurality of first PDU power interfaces 111, a plurality of sides 102, an open bottom 106 and an open top 116. Busbars 104 are metallic bars that provide high current power distribution from first PDU 101. Busbars 104 are preferably uninsulated, which allows busbars from other PDUs to electrically connect thereto. Busbars 104 are preferably electrically coupled to power interfaces 111 to provide electrical power to power interfaces 111. Power interfaces 111 may be, for example, single or multiple pole connectors.

First PDU 101 preferably includes an open top 116 that is sized to receive second PDU 103. Open top 116 allows the exposure of busbars 104 that function as the main electrical conductors inside of the box. In accordance with an exemplary embodiment, the placement of second PDU 103 onto first PDU 101 forms a hermetic seal to keep out liquid and small particles from stackable power distribution system 100. A hermetic seal may be created by welding the components together or with the use of a gasket 131 that may be made from a dispensed material, may be pre-formed or may be an adhesive, but the seal may be created by other processes and is not limited to these specific examples.

Second PDU 103 preferably comprises busbars 105, a plurality of second PDU power interfaces 121, a plurality of sides 122 an open bottom 126 and an open top 128 Busbars 105 are metallic bars that provide high current power distribution from second PDU 103. Busbars 105 are preferably uninsulated, which allows busbars from other PDUs to electrically connect thereto. Busbars 105 are preferably electrically coupled to second PDU power interfaces 121 to provide electrical power to second PDU power interfaces 121. Second PDU power interfaces 121 may be, for example, single or multiple pole connectors. Second PDU 103 preferably includes an open bottom 126 that is sized to couple with open top 116 of first PDU 101.

Electrical connection fasteners 107 are conductive fasteners that preferably provide electrical connection between busbars 104 and busbars 105. Electrical connection fasteners 107 also preferably provide a mechanical connection between busbars 104 and busbars 105, and thereby between first PDU 101 and second PDU 103.

Lower lid 108 covers and seals bottom 106, which protects the electrically conductive internal parts of stackable power distribution system 100 from external agents. Lower lid 108 may cover and hermetically seal open bottom 106 to keep out liquid and small particles from stackable power distribution system 100.

Upper lid 109 covers and seals top 128, which protects the electrically conductive internal parts of stackable power distribution system 100 from external agents. Upper lid 109 may cover and hermetically seal open top 128, which protects the electrically conductive internal parts of stackable power distribution system 100 from external agents. As described above, such hermetic seals described in the present disclosure may be created in a variety of ways, such as by welding the components together or with the use of a gasket 131 that may be made from a dispensed material, may be pre-formed or may be an adhesive, but the seal may be created by other processes and is not limited to these specific examples. In an exemplary embodiment, lower lid 108 and upper lid 109 may be made of a metal or polymer but may not be limited to these materials and can be any other suitable material.

There may be n PDUs in the power distribution system 100, each of the n PDUs being substantially the same as first and second PDUs 101 and 103 described herein, where n can be any number greater than 2.

According to a first aspect, a power distribution system 100 is disclosed. The power distribution system 100 may include a first Power Distribution Unit (PDU) 101 having at least one first PDU side 102 including a plurality of first PDU power interfaces 111, at least two first PDU busbars 104, and a first PDU top opening 116 that exposes the at least two first PDU busbars 104. The power distribution system 100 may further include a second PDU 103 having at least one second PDU side 122 including a plurality of second PDU power interfaces 121, at least two second PDU busbars 105, and a second PDU bottom opening 126 that exposes the at least two second PDU busbars 105. The power distribution system 100 may further include at least two electrical connection fasteners 107, the at least two electrical connection fasteners 107 electrically connecting the at least two first PDU busbars 104 to the at least two second PDU busbars 105. The first PDU 101 may further include a first PDU bottom opening 106 and the power distribution system 100 further includes a bottom lid 108 that hermetically seals the first PDU bottom opening 106. The second PDU 103 may further include a second PDU top opening 128 and the power distribution system 100 further includes a top lid 109 that hermetically seals the second PDU top opening 128. The first PDU top opening 116 and the second PDU bottom opening 126 may be formed to fit together. The first PDU top opening 116 and the second PDU bottom opening 126 may form a hermetic seal when fitted together. The power distribution system 100 may further include a third PDU that couples with the second PDU 103. The at least two electrical connection fasteners 107 may further provide a mechanical attachment between the first PDU 101 and the second PDU 103. The plurality of first PDU power interfaces 111 may be High Voltage (HV) power outputs. The plurality of second PDU power interfaces 121 may also be High Voltage (HV) power outputs. The power distribution system 100 may further include a plurality of fuses located with the first PDU 101.

According to a second aspect, a power distribution system 100 is disclosed. The power distribution system 100 may include a first Power Distribution Unit (PDU) 101 having at least one first PDU side 102 including a plurality of first PDU power interfaces 111, at least two first PDU busbars l104 located inside the first PDU 101, and a first PDU top opening 116 that exposes the at least two first PDU busbars 104. The power distribution system 100 may include a second PDU 103 having at least one second PDU side 122 including a plurality of second PDU power interfaces 121, at least two second PDU busbars 105 located inside the second PDU 103, and a second PDU bottom opening 126 that exposes the at least two second PDU busbars 105; and at least two electrical connection fasteners 107. The at least two electrical connection fasteners 107 electrically connect the at least two first PDU busbars l04 located inside the first PDU 101 to the at least two second PDU busbars 105 located inside the second PDU 103. The at least two electrical connection fasteners 107 may further provide a mechanical attachment between the first PDU 101 and the second PDU 103. The first PDU 101 may further include a first PDU bottom opening 106 and the power distribution system 100 further includes a bottom lid 108 sized and shaped to mate with an edge of the second PDU 103 that defines the second PDU bottom opening 126 and an edge of the first PDU 101 that defines the first PDU bottom opening 106. The second PDU 103 may further include a second PDU top opening 128 and the power distribution system 100 further includes a top lid 109 sized and shaped to mate with an edge of the second PDU that defines the second PDU top opening 128 and an edge of the first PDU 101 that defines the first PDU top opening 116. The first PDU top opening 116 and the second PDU bottom opening 126 may be formed to fit together. The first PDU top opening 116 and the second PDU bottom opening 126 may form a hermetic seal when fitted together. The power distribution system 100 may include a gasket 131 between the first PDU top opening 116 and the second PDU bottom opening 126 that forms the hermetic seal when fitted together.

According to a third aspect, a power distribution system 100 is disclosed. The power distribution system 100 includes a first Power Distribution Unit (PDU) 101 having at least one first PDU side 102 including a plurality of first PDU power interfaces 111, at least two first PDU busbars 104 located inside the first PDU 101, and a first PDU top opening 116 and a first PDU bottom opening 106 that expose the at least two first PDU busbars 104. The power distribution system 100 includes a second PDU 103 having at least one second PDU side 122 including a plurality of second PDU power interfaces 121, at least two second PDU busbars 105 located inside the second PDU 103, and a second PDU bottom opening 126 and a second PDU top opening 128 that expose the at least two second PDU busbars 105. The power distribution system 100 includes at least two electrical connection fasteners 107, the at least two electrical connection fasteners 107 electrically connecting the at least two first PDU busbars 104 located inside the first PDU 101 to the at least two second PDU busbars 105 located inside the second PDU 103. The power distribution system 100 includes a bottom lid 108 that hermetically seals the first PDU bottom opening 106; and a top lid 109 that hermetically seals the second PDU top opening 128; and the first PDU top opening 116 and the second PDU bottom opening 126 are formed to fit together. The first PDU top opening 116 and the second PDU bottom opening 126 may form a hermetic seal when fitted together. The at least two electrical connection fasteners 107 may provide a mechanical attachment between the first PDU 101 and the second PDU 103.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the present invention and is presented for the purpose of enabling those skilled in the art to make and use the present invention and to teach the best mode of carrying out same. The exclusive rights to all modifications which come within the scope of the appended claims are reserved. All patents, patent publications and applications, and other references cited herein are incorporated by reference herein in their entirety.

We claim:

1. A power distribution system comprising:
a first Power Distribution Unit (PDU) comprising at least one first PDU side including a plurality of first PDU power interfaces, at least two first PDU busbars, and a first PDU top opening that exposes the at least two first PDU busbars;
a second PDU comprising at least one second PDU side including a plurality of second PDU power interfaces, at least two second PDU busbars, and a second PDU bottom opening that exposes the at least two second PDU busbars; and
at least two electrical connection fasteners, wherein the at least two electrical connection fasteners electrically connect the at least two first PDU busbars to the at least two second PDU busbars.

2. The power distribution system in accordance with claim 1, wherein the first PDU further comprises a first PDU bottom opening, the power distribution system further comprising a bottom lid that hermetically seals the first PDU bottom opening.

3. The power distribution system in accordance with claim 1, wherein the second PDU further comprises a second PDU top opening, the power distribution system further comprising a top lid that hermetically seals the second PDU top opening.

4. The power distribution system in accordance with claim 1, wherein the first PDU top opening and the second PDU bottom opening are formed to fit together.

5. The power distribution system in accordance with claim 4, wherein the first PDU top opening and the second PDU bottom opening form a hermetic seal when fitted together.

6. The power distribution system in accordance with claim 1, further comprising a third PDU that couples with the second PDU.

7. The power distribution system in accordance with claim 1, wherein the at least two electrical connection fasteners provide a mechanical attachment between the first PDU and the second PDU.

8. The power distribution system in accordance with claim 1, wherein the plurality of first PDU power interfaces are High Voltage (HV) power outputs.

9. The power distribution system in accordance with claim 1, wherein the plurality of second PDU power interfaces are High Voltage (HV) power outputs.

10. The power distribution system in accordance with claim 1, further comprising a plurality of fuses located with the first PDU.

11. A power distribution system comprising:
a first Power Distribution Unit (PDU) comprising at least one first PDU side including a plurality of first PDU power interfaces, at least two first PDU busbars located inside the first PDU, and a first PDU top opening that exposes the at least two first PDU busbars;
a second PDU comprising at least one second PDU side including a plurality of second PDU power interfaces, at least two second PDU busbars located inside the second PDU, and a second PDU bottom opening that exposes the at least two second PDU busbars; and
at least two electrical connection fasteners, wherein the at least two electrical connection fasteners electrically connect the at least two first PDU busbars located inside the first PDU to the at least two second PDU busbars located inside the second PDU.

12. The power distribution system in accordance with claim 11, wherein the at least two electrical connection fasteners provide a mechanical attachment between the first PDU and the second PDU.

13. The power distribution system in accordance with claim 11, wherein the first PDU further comprises a first PDU bottom opening, the power distribution system further comprising a bottom lid sized and shaped to mate with an edge of the second PDU that defines the second PDU bottom opening and an edge of the first PDU that defines the first PDU bottom opening.

14. The power distribution system in accordance with claim 11, wherein the second PDU further comprises a second PDU top opening, the power distribution system further comprising a top lid sized and shaped to mate with an edge of the second PDU that defines the second PDU top opening and an edge of the first PDU that defines the first PDU top opening.

15. The power distribution system in accordance with claim 11, wherein the first PDU top opening and the second PDU bottom opening are formed to fit together.

16. The power distribution system in accordance with claim 15, wherein the first PDU top opening and the second PDU bottom opening form a hermetic seal when fitted together.

17. The power distribution system in accordance with claim 16, further comprising a gasket between the first PDU top opening and the second PDU bottom opening that forms the hermetic seal when fitted together.

18. A power distribution system comprising:
a first Power Distribution Unit (PDU) comprising at least one first PDU side including a plurality of first PDU power interfaces, at least two first PDU busbars located inside the first PDU, and a first PDU top opening and a first PDU bottom opening that expose the at least two first PDU busbars;
a second PDU comprising at least one second PDU side including a plurality of second PDU power interfaces, at least two second PDU busbars located inside the second PDU, and a second PDU bottom opening and a second PDU top opening that expose the at least two second PDU busbars;
at least two electrical connection fasteners, wherein the at least two electrical connection fasteners electrically connect the at least two first PDU busbars located inside the first PDU to the at least two second PDU busbars located inside the second PDU;
a bottom lid that hermetically seals the first PDU bottom opening; and
a top lid that hermetically seals the second PDU top opening; and
wherein the first PDU top opening and the second PDU bottom opening are formed to fit together.

19. The power distribution system in accordance with claim 18, wherein the first PDU top opening and the second PDU bottom opening form a hermetic seal when fitted together.

20. The power distribution system in accordance with claim 18, wherein the at least two electrical connection fasteners provide a mechanical attachment between the first PDU and the second PDU.
